(19) United States
(12) Patent Application Publication
(10) Pub. No.: US 2024/0116333 A1
(43) Pub. Date: Apr. 11, 2024

(54) HEATER FOR ELECTRIC VEHICLE

(71) Applicant: EVERWELL TECHNOLOGY CO., LTD, Daejeon (KR)

(72) Inventor: Su Nam YU, Daejeon (KR)

(73) Assignee: EVERWELL TECHNOLOGY CO., LTD, Daejeon (KR)

(21) Appl. No.: 17/973,854

(22) Filed: Oct. 26, 2022

(30) Foreign Application Priority Data
Oct. 11, 2022 (KR) 10-2022-0129756

(51) Int. Cl. B60H 1/22; B60H 1/00

(52) U.S. Cl. CPC B60H 1/2226; B60H 1/00742; B60H 1/2218

(57) ABSTRACT

The present invention relates to a heater for an electric vehicle, including: a radiator disposed in the electric vehicle to radiate heat when power is supplied thereto; a power supply part disposed in the electric vehicle to supply the power to the radiator; and a controller for controlling the operation of the power supply part, wherein the radiator is made of a carbon material and emits far infrared light therefrom when the power is supplied from the power supply part thereto. According to the present invention, the radiator emits the far infrared light to enable the heat to be applied directly to a user's body, thereby reducing an amount of power consumed unnecessarily and providing high thermal comfort for the user.

### CROSS REFERENCE TO RELATED APPLICATION OF THE INVENTION

The present application claims the benefit of Korean Patent Application No. 10-2022-0129756 filed in the Korean Intellectual Property Office on 11 Oct. 2022 the entire contents of which are incorporated herein by reference.

### BACKGROUND OF THE INVENTION

### Field of the Invention

The present invention relates to a heater for an electric vehicle, and more specifically, to a heater for an electric vehicle that is capable of allowing a radiator adapted to emit heat when power is supplied from a power supply part thereto to be made of a carbon material so that the radiator emits far infrared light to enable the heat to be applied directly to a user's body, thereby reducing an amount of power consumed unnecessarily and providing high thermal comfort for the user.

### BACKGROUND OF THE RELATED ART

As industries are developed and living levels are improved, it is desirably appreciated that an automobile is not only transportation but also a comfortable working and resting space.

According to the results of one survey, further, adults living in a city spend 95% of a day indoors and 7% of a day inside a vehicle.

Accordingly, the analysis and evaluation technologies for the thermal environment and air quality having the biggest influence on a vehicle occupant's thermal comfort have emerged as very important issues, and further, comport, quietness, and pleasant indoor environment creation of the automobile are importantly considered when consumers choose their automobile.

In this case, at present, a vehicle having an engine as a driving source with an energy source such as gasoline, diesel oil, and the like is the most common vehicle among vehicles, but such an energy source causes environmental pollution. Owing to various reasons such as the reduction of oil reserves, further, the necessity for new energy sources has emerged, and recently, electric vehicles, hybrid vehicles, and fuel cell electric vehicles have been put into practice or have been developed.

Unlike the vehicle having the engine using petroleum as the energy source, the electric vehicles, the hybrid vehicles, and the fuel cell electric vehicles cannot adopt a positive temperature coefficient (PTC) heating system in which cooling water is used to provide high price competitiveness and operability at a low temperature, or they have difficulties in adopting the PTC heating system.

In the case of the vehicle having the driving source engine using petroleum as the energy source, a large amount of heat is generated from the engine, and accordingly, a cooling water circulation system is provided to make the engine cool, so that the heat absorbed from the engine to the cooling water is used for indoor heating.

That is, such a large amount of heat, which is generated from the engine, is not generated from the driving sources of the electric vehicles, the hybrid vehicles, and the fuel cell electric vehicles, and accordingly, it is hard to apply the conventional heating system to the electric vehicles, the hybrid vehicles, and the fuel cell electric vehicles.

In the case of the electric vehicles, the hybrid vehicles, and the fuel cell electric vehicles, accordingly, a heat pump, which recovers heat in the air in an outdoor heat exchanger in a heating mode, evaporates a refrigerant, transfers the refrigerant compressed in a compressor to an indoor heat exchanger, and performs indoor heating, is added to an air conditioning system and used as a heat source, and otherwise, a heat source like an electric heater is separately provided.

One of conventional technologies relating thereto is disclosed in Japanese Patent Application Laid-open No. 20056044 entitled “Heat transfer medium heating device and vehicle air conditioner using the same”.

However, the heat transfer medium heating device and the vehicle air conditioner using the same in the conventional practice is configured to allow a housing including a heating element to be made of an aluminum die-casting material to provide excellent mechanical strength and serves to form a cooling water path, but the housing made of the aluminum die-casting material may cause occurrence of surface corrosion and structural cracks. While the heating device is operating, besides, a heat loss and a low thermal efficiency may be generated by means of the aluminum die-casting material, and if foreign matters are generated from the aluminum die-casting material, they may have a bad influence on the operational performance of electrification parts through the cooling water path.

In specific, the above-mentioned conventional technology is configured to allow the heat pump to be applied at an external air temperature greater than −10° C. and to allow an electric heater to be applied at a temperature less than −10° C., thereby lowering the efficiency of the heat pump. Further, it is hard to use even the electric heater at an external air temperature less than −20° C.

### SUMMARY OF THE INVENTION

Accordingly, the present invention has been made in view of the above-mentioned problems occurring in the related art, and it is an object of the present invention to provide a heater for an electric vehicle that is capable of allowing a radiator adapted to emit heat when power is supplied from a power supply part thereto to be made of a carbon material so that the radiator emits far infrared light to enable the heat to be applied directly to a user's body, thereby reducing an amount of power consumed unnecessarily and providing high thermal comfort for the user.

To accomplish the above-mentioned objects, according to the present invention, there is provided a heater for an electric vehicle, including: a radiator having a first base material, a plurality of heating parts disposed spaced apart from one another on the underside of the first base material to emit heat when power is supplied thereto, an adhesion layer disposed on the undersides of the plurality of heating parts to allow the plurality of heating parts to come into contact with the first base material, and a second base material disposed under the adhesion layer; a power supply part disposed in the electric vehicle to supply the power to the radiator; and a controller for controlling the operation of the power supply part, wherein the adhesion layer is disposed on the undersides of the plurality of heating parts, bent between the neighboring heating parts, and bonded to the underside of the first base material to support the undersides of the plurality of heating parts, so that first air layers are formed among the first base material, the heating parts, and the adhesion layer, and the second base material is disposed under the adhesion layer, bent between the neighboring heating parts, and bonded to the adhesion layer, so that second air layers are formed between the adhesion layer and the second base material.

According to the present invention, desirably, the radiator may be located on one or more positions of a steering wheel, doors, seats, a ceiling, arm rests, and internal frames in the electric vehicle.

According to the present invention, desirably, the controller may control the amount of heat emitted from the radiator.

According to the present invention, desirably, the heater may further include a detection sensor part for transmitting sensed information to the controller, the detection sensor part including: a boarding detection sensor for detecting whether a user sits on a seat of the electric vehicle to produce boarding information; and a body temperature detection sensor for detecting the body temperature of the user to produce body temperature information if it is detected that the user sits on the seat.

According to the present invention, desirably, the boarding detection sensor may include: a surface type sensing member made of a flexible material and disposed on the seat of the electric vehicle; a first conductive mesh coming into contact with one surface of the surface type sensing member; a second conductive mesh coming into contact with the other surface of the surface type sensing member; and an insulating member provided to surround the first conductive mesh and the second conductive mesh.

According to the present invention, desirably, the heater may further include a user terminal for transmitting the control signals inputted therewith to the controller, so that the controller controls the operation of the power supply part according to the control signals received from the user terminal.

According to the present invention, desirably, the radiator may include: a heat diffusion sheet attached to top of the first base material to diffuse the heat emitted from the heating parts; and an outer sheet attached to top of the heat diffusion sheet.

### BRIEF DESCRIPTION OF THE DRAWINGS

The above and other objects, features and advantages of the present invention will be apparent from the following detailed description of the embodiments of the invention in conjunction with the accompanying drawings, in which:

FIG. 1 is a block diagram showing a configuration of a heater for an electric vehicle according to the present invention;

FIG. 2 is a sectional view showing a radiator of the heater for an electric vehicle according to the present invention;

FIGS. 3A and 3B are diagrams showing a detection sensor part of the heater for an electric vehicle according to the present invention;

FIG. 4A is a top view showing a boarding detection sensor of the heater for an electric vehicle according to the present invention;

FIG. 4B is a top view showing a conventional detection sensor; and

FIG. 5 is a diagram showing a user terminal of the heater for an electric vehicle according to the present invention.

### DETAILED DESCRIPTION OF THE EMBODIMENTS

The present invention may be modified in various ways and may have several exemplary embodiments. Specific exemplary embodiments of the present invention are illustrated in the drawings and described in detail in the detailed description. However, this does not limit the invention within specific embodiments and it should be understood that the invention covers all the modifications, equivalents, and replacements within the idea and technical scope of the invention.

When it is said that one element is described as being “connected” or “coupled” to the other element, one element may be directly connected or coupled to the other element, but it should be understood that another element may be present between the two elements.

In contrast, when it is said that one element is described as being “directly connected” or “directly coupled” to the other element, it should be understood that another element is not present between the two elements.

Terms used in this application are used to only describe specific exemplary embodiments and are not intended to restrict the present invention. An expression referencing a singular value additionally refers to a corresponding expression of the plural number, unless explicitly limited otherwise by the context. In this application, terms, such as “comprise”, “include”, or ‘have”, are intended to designate those characteristics, numbers, steps, operations, elements, or parts which are described in the specification, or any combination of them that exist, and it should be understood that they do not preclude the possibility of the existence or possible addition of one or more additional characteristics, numbers, steps, operations, elements, or parts, or combinations thereof.

All terms used herein, including technical or scientific terms, unless otherwise defined, have the same meanings which are typically understood by those having ordinary skill in the art. The terms, such as ones defined in common dictionaries, should be interpreted as having the same meanings as terms in the context of pertinent technology, and should not be interpreted as having ideal or excessively formal meanings unless clearly defined in the specification.

Hereinafter, the present invention will now be described in detail with reference to the attached drawings. Before the present invention is disclosed and described, all terms used herein, including technical or scientific terms, unless otherwise defined, have the same meanings which are typically understood by those having ordinary skill in the art. The terms, such as ones defined in common dictionaries, should be interpreted as having the same meanings as terms in the context of pertinent technology, and should not be interpreted as having ideal or excessively formal meanings unless clearly defined in the specification. If it is determined that the detailed explanation on the well known technology related to the present invention makes the scope of the present invention not clear, the explanation will be avoided for the brevity of the description. The present invention may be modified in various ways and may have several exemplary embodiments. In the description, it should be noted that the parts corresponding to those of the drawings are indicated by corresponding reference numerals.

The present invention relates to a heater for an electric vehicle that is capable of allowing a radiator adapted to emit heat when power is supplied from a power supply part thereto to be made of a carbon material so that the radiator emits far infrared light to enable the heat to be applied directly to a user's body, thereby reducing an amount of power consumed unnecessarily and providing high thermal comfort for the user.

Hereinafter, an explanation of a heater for an electric vehicle according to the present invention will be given in detail with reference to the attached drawings.

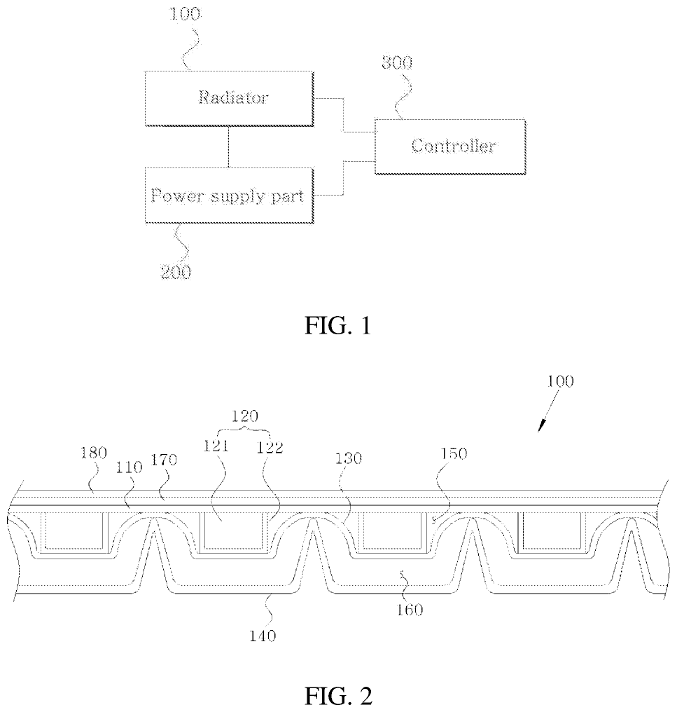

Referring to FIGS. 1 and 2, the heater for an electric vehicle according to the present invention includes a radiator 100 disposed in the electric vehicle to emit heat when power is supplied thereto, a power supply part 200 disposed in the electric vehicle to supply the power to the radiator 100, and a controller 300 for controlling the operation of the power supply part 200.

The heater for an electric vehicle according to the present invention is disposed in the electric vehicle and adapted to control an indoor air temperature so as to reduce power consumed for air conditioning in the electric vehicle and to evaluate the thermal comfort in the electric vehicle for a vehicle occupant so as to provide instantaneous air conditioning to the vehicle occupant.

The performance of the electric vehicle becomes drastically degraded because the electricity of a battery is used for other devices therein.

In specific, if the electricity consumption for heating, ventilating and air conditioning is reduced as much as possible, the performance of the electric vehicle is exerted sufficiently, and the PTC heater at present adopted for heating in the electric vehicle has a large amount of electricity consumed, which is the principal cause of the performance degradation of the electric vehicle.

Therefore, the heater for the electric vehicle according to the present invention is configured to allow power to be supplied to the radiator 100 made of a carbon material so that radiant heat is applied to the vehicle occupant to improve the electricity efficiency of the electric vehicle.

The radiator 100 is made of the carbon material and emits far infrared light therefrom when the power is supplied from the power supply part 200 thereto so that it supplies the radiant heat to the vehicle occupant and provides effectiveness good to the human body, such as soft heat, sterilization effects, low temperature burn prevention, and the like.

Accordingly, the radiator 100 emits 200 to thousands of times more far infrared light than surface heating elements and makes the vehicle occupant feel pleasant and warm even at a relatively low temperature (e.g., 43° C.)

Further, the radiator 100 is prepared through a raw material manufacturing step, an impregnation step, a curing step, a skiving step, and a machining step.

The raw material manufacturing step is carried out to manufacture a raw material using the carbon material, the impregnation step is carried out to impregnate the raw material into a given impregnating liquid, the curing step is carried out to allow the impregnated raw material to be subjected to treatments at a predetermined temperature and moisture for a given period of time to cure the raw material, the skiving step is carried out to skive the underside of the raw material cured in the curing step to adjust the thickness of the raw material, and the machining step is carried out to cut the skived raw material according to an installation position.

The radiator 100 includes a first base material 110, a plurality of heating parts 120, an adhesion layer 130, and a second base material 140.

The first base material 110 comes into contact with the plurality of heating parts 120 as will be discussed later to transfer the heat generated from the plurality of heating parts 120.

The plurality of heating parts 120 are disposed spaced apart from one another on the underside of the first base material 110 to emit the heat when power is supplied thereto.

Each heating part 120 includes a heating element 121 and a heating element protection layer 122 for surrounding the heating element 121.

Further, the heating element 121 is a carbon felt heating element, and the heating element protection layer 122 is made of a flame-resistant and insulating material.

For example, the heating element protection layer 122 may be made of a polyamide material, but it may be freely made of a material with flame-resistance and insulation according to its embodiment environment.

The adhesion layer 130 is disposed on the undersides of the plurality of heating parts 120, bent between the neighboring heating parts 120, and thus bonded to the underside of the first base material 110 to support the undersides of the plurality of heating parts 120.

That is, the adhesion layer 130 is bent between the neighboring heating parts 120 and bonded to the underside of the first base material 110 so that it serves to fix the plurality of heating parts 120 in position or to prevent the plurality of heating parts 120 from being excessively changed in position.

The adhesion layer 130 is bonded to the first base material 110 by means of heat fusion or high frequency fusion, and otherwise, the adhesion layer 130 is attached to the first base material 110 by means of an adhesive.

The second base material 140 is disposed under the adhesion layer 130, bent between the neighboring heating parts 120, and bonded to the adhesion layer 130.

The first base material 110, the adhesion layer 130, and the second base material 140 may be made of materials capable of being bonded to one another by means of heat fusion or high frequency fusion.

For example, the first base material 110, the adhesion layer 130, and the second base material 140 may be made of thermoplastic polyurethane (TPU), and as they are made of the same material as one another, accordingly, their manufacturing efficiency may be more improved than that when they are made of different materials.

Further, the radiator 100 has first air layers 150 formed among the first base material 110, the heating parts 120, and the adhesion layer 130 and second air layers 160 formed between the adhesion layer 130 and the second base material 140.

In this case, the first air layers 150 and the second air layers 160 are filled with air or fillers, and the fillers may be urethane foams or memory foams.

As the first air layers 150 and the second air layers 160 are filled with air or fillers, accordingly, the radiator 100 makes the user feel soft like a cushion and further improves the insulation performance thereof.

Further, the radiator 100 has a given thickness so that the first air layers 150 and the second air layers 160 are formed to sufficient areas in which the air or fillers is (are) filled fully.

For example, the patent right for the carbon felt heating element (Korean Patent Application Laid-open No. 10-2018-0002463) is issued to the same applicant as the present invention, and the carbon felt heating element has a given thickness so that it provides air layers or fillers, which is different from a sheet type surface heating element or a conductive line type wire heating element.

That is, it can be appreciated that the areas of the first air layers 150 and the second air layers 160 are determined according to the thickness of the radiator 100, and therefore, the radiator 100 has an appropriate thickness so that the first air layers 150 and the second air layers 160 are filled with the air or fillers.

Further, the radiator 100 includes a heat diffusion sheet 170 attached to top of the first base material 110 to diffuse the heat emitted from the heating parts 120 and an outer sheet 180 attached to top of the heat diffusion sheet 170.

In this case, the outer sheet 180 comes into contact with the user's skin and is thus made of a material capable of providing no reluctant or uncomfortable feeling to the user.

In more detail, the outer sheet 180 is made of a fiber material capable of making the user have a smooth feel, but it may be freely made of other materials providing no reluctant or uncomfortable feeling to the user according to its embodiment environment.

Moreover, the radiator 100 is flexible so that it can be freely located on one or more positions of a steering wheel, doors, seats, a ceiling, arm rests, and internal frames in the electric vehicle.

In specific, as shown in FIG. 2, the radiator 100 is supplied to the shape wound on a roll, and accordingly, it is cut to sizes and shapes appropriate to one or more positions of a steering wheel, doors, seats, a ceiling, arm rests, and internal frames in the electric vehicle.

That is, the radiator 100 is made of a thin film with a thickness of 3 mm or under at which electrical characteristics are kept and thus flexible to provide higher machinability than the existing heating panels, so that it can be easily located on one or more positions of a steering wheel, doors, seats, a ceiling, arm rests, and internal frames in the electric vehicle.

In specific, the radiator 100 is configured to evenly distribute the heat therein, unlike the wire type heating element, thereby improving the thermal efficiency thereof.

The controller 300 serves to control the amount of heat emitted from the radiator 100.

In this case, the controller 300 is adapted to control the amount of power supplied to the radiator 100 from the power supply part 200, so that the amount of heat emitted from the radiator 100 can be controlled.

The controller 300 is disposed in the electric vehicle to transmit control signals through the user's button control.

That is, the controller 300 controls the amount of heat emitted from the radiator 100 to allow the far infrared light to be supplied directly to the body of the user boarding the electric vehicle.

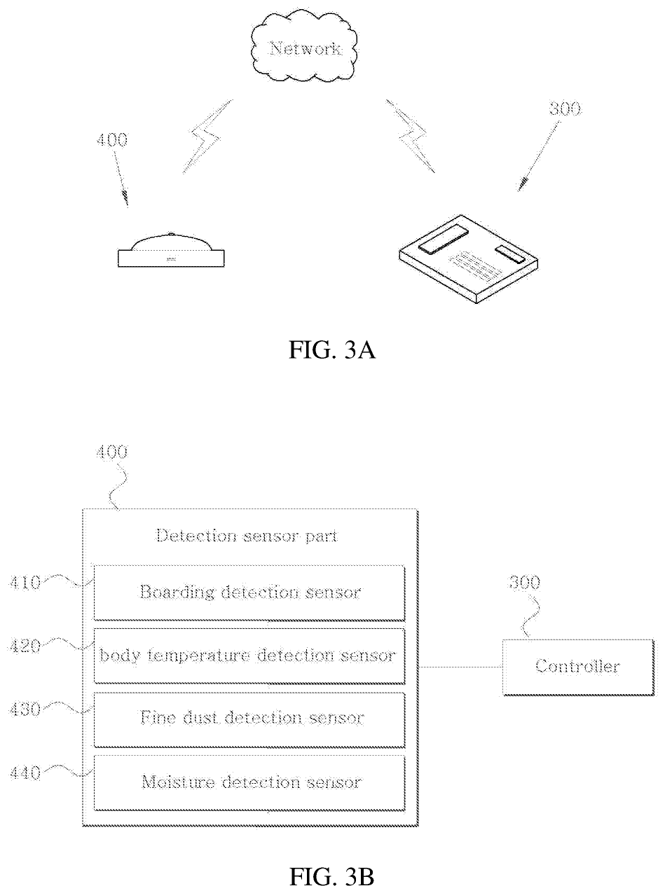

FIGS. 3A and 3B are diagrams showing a detection sensor part of the heater for an electric vehicle according to the present invention.

Referring to FIGS. 3A and 3B, the heater for the electric vehicle according to the present invention further includes a detection sensor part 400 for transmitting sensed information to the controller 300.

Accordingly, the controller 300 controls the amount of power supplied to the radiator 100 from the power supply part 200 according to the information received from the detection sensor part 400, so that the heat supplied can be automatically controlled, without being controlled directly by the user boarding the electric vehicle.

The detection sensor part 400 includes a boarding detection sensor 410 for detecting whether the user sits on a seat of the electric vehicle to produce boarding information and a body temperature detection sensor 420 for detecting the body temperature of the user to produce body temperature information if it is detected that the user sits on the seat.

Accordingly, the detection sensor part 400 transmits the boarding information produced from the boarding detection sensor 410 and the body temperature information produced from the body temperature detection sensor 420 to the controller 300, and the controller 300 controls the operation of the power supply part 200 based on the boarding information and the body temperature information received from the detection sensor part 400 to thus allow the heat with a given temperature to be emitted from the radiator 100.

In specific, the controller 300 determines whether how many users board the electric vehicle according to the boarding information received and determines the states of the body temperatures of the users boarding in the electric vehicle according to the body temperature information received, so that the controller 300 allows the heat with a given appropriate temperature to be emitted from the radiator 100.

That is, the controller 300 controls the amount of power supplied to the radiator 100 from the power supply part 200 according to the information received from the detection sensor part 400 and thus controls the heat emitted from the radiator 100, so that the heat supplied from the radiator 100 can be automatically controlled, without being controlled directly by the occupant of the electric vehicle.

Further, the detection sensor part 400 includes one or both of a fine dust detection sensor 430 for detecting the fine dust in the electric vehicle to produce air quality information and a moisture detection sensor 440 for detecting internal moisture of the electric vehicle to produce moisture information.

If the detection sensor part 400 transmits the air quality information produced from the fine dust detection sensor 430 to the controller 300, the controller 300 receives the air quality information and controls an air cleaning operation according to the received air quality information, so that the air quality in the electric vehicle can be automatically improved, without any separate control.

If the detection sensor part 400 transmits the moisture information produced from the moisture detection sensor 440 to the controller 300, the controller 300 receives the moisture information and controls an air ventilating operation according to the received moisture information, so that the moisture state in the electric vehicle can be automatically improved, without any separate control.

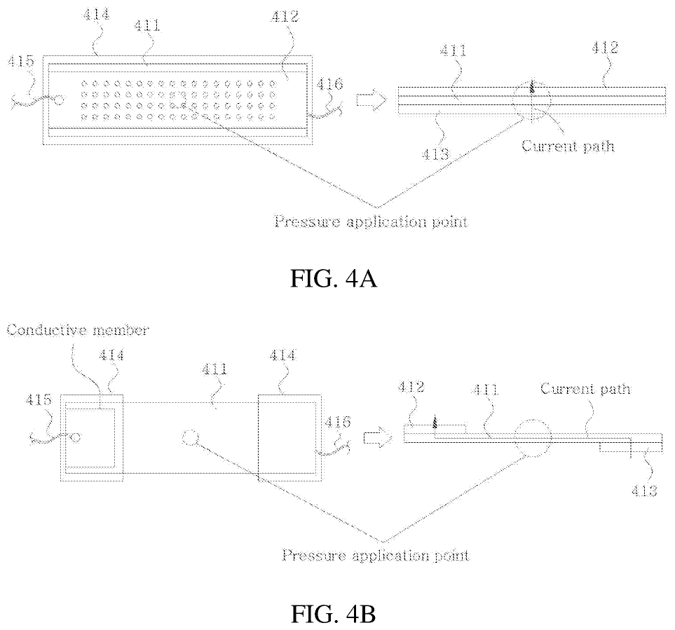

FIG. 4A is a top view showing the boarding detection sensor of the heater for an electric vehicle according to the present invention, and FIG. 4B is a top view showing a conventional detection sensor.

Referring to FIGS. 4A and 4B, the boarding detection sensor 410 of the detection sensor part 400 includes a surface type sensing member 411, a first conductive mesh 412, a second conductive mesh 413, and an insulating member 414.

Further, the boarding detection sensor 410 includes a first conductive wire 415 electrically connected to the first conductive mesh 412 and a second conductive wire 416 electrically connected to the second conductive mesh 413.

The surface type sensing member 411 is made of a flexible material and changed in resistance according to a pressure applied thereto, so that it may be disposed on the seat of the electric vehicle.

In specific, the surface type sensing member 411 desirably has to have given degree of flexibility so that it may be made of Velostat.

The first conductive mesh 412 comes into contact with one surface of the surface type sensing member 411, and the second conductive mesh 413 comes into contact with the other surface of the surface type sensing member 411, so that the pressure applied can be easily sensed using the boarding detection sensor 410 to allow the sitting state of the user boarding the electric vehicle to be easily detected.

The insulating member 414 is provided to surround the first conductive mesh 412 and the second conductive mesh 413.

In this case, FIG. 4A shows the boarding detection sensor 410 according to the present invention, and FIG. 4B shows one conventional detection sensor.

As shown in FIG. 4A, the boarding detection sensor 410 according to the present invention is configured to allow the first conductive mesh 412 and the second conductive mesh 413 to extend from one end of the surface type sensing member 411 to the other end of the surface type sensing member 41 after passing through the central area of the surface type sensing member 411.

However, as shown in FIG. 4B, the conventional detection sensor is configured to allow conductive members to be located only on one end and the other end of the surface type sensing member 411.

As shown in FIGS. 4A and 4B, if a given pressure is applied to the same position as of the surface type sensing member 411 of the present invention and the conventional surface type sensing member 411, the boarding detection sensor 410 according to the present invention has a shorter current path than the conventional detection sensor through the first conductive mesh 412 and the second conductive mesh 413 extending as shown in FIG. 4A.

As shown in FIG. 4B, contrarily, if the conductive members are located on both ends of the surface type sensing member 411, the current path may become long to make a degree of accuracy in sensing the applied pressure deteriorated.

Accordingly, the applied pressure can be more accurately sensed by means of the first conductive mesh 412 and the second conductive mesh 413 extending from one end of the surface type sensing member 411 to the other end thereof.

Further, as shown in FIG. 4A, the boarding detection sensor 410 has a plurality of holes formed on the first conductive mesh 412 and the second conductive mesh 413, respectively. As the conductive meshes having the holes are used, accordingly, the radiator 100 of the present invention can be bent or folded to improve the conveniences of the user while used.

That is, the first conductive mesh 412 and the second conductive mesh 413 according to the present invention are provided with the plurality of holes, so that they have better flexibility than the conductive sheet having no holes.

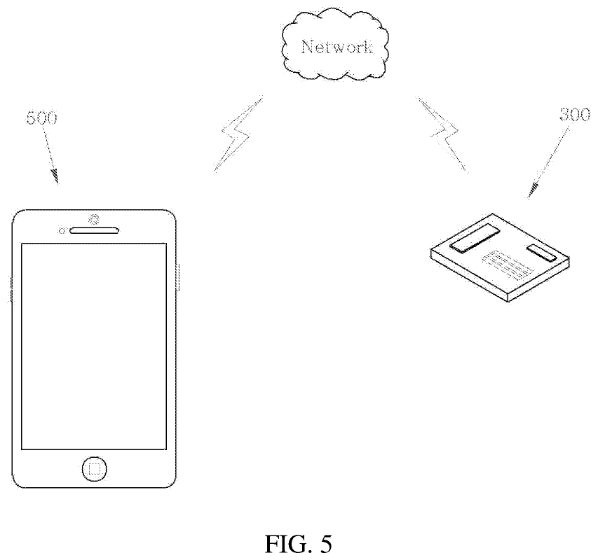

FIG. 5 is a diagram showing a user terminal of the heater for an electric vehicle according to the present invention.

As shown in FIG. 5, the heater for the electric vehicle according to the present invention further includes a user terminal 500 for transmitting the control signals inputted therewith to the controller 300.

The controller 300 controls the operation of the power supply part 200 according to the control signals received from the user terminal 500, so that even in a state where the user does not board the electric vehicle, the controller 300 remotely controls the power supply part 200 to supply heat to the interior of the electric vehicle.

The user terminal 500 has an application installed therein, which is received from a central server, to transmit the control signals to the controller 300 by means of the user's control, and a smartphone, a tablet PC, and the like, which are generally used, may be used as the user terminal 500.

Accordingly, the user terminal 500 transmits the control signals inputted by the user to the controller 300, and the controller 300 controls the operation of the power supply part 200 according to the control signals received from the user terminal 500 to allow heat to be emitted from the radiator 100.

In specific, the user terminal 500 transmits any one of an On/Off signal and a temperature control signal for the power supply part 200 inputted by the user to the controller 300, and the On/Off signal and the temperature control signal are transmitted according to predetermined information before they are first transmitted to the controller 300.

That is, when the power supply part 200 operates using the user terminal 500, the user predetermines a setting temperature of the power supply part 200, and accordingly, the user terminal 500 transmits the predetermined setting temperature information to the controller 300.

As described above, the heater for the electric vehicle according to the present invention is configured to allow the radiator adapted to emit heat when power is supplied from the power supply part thereto to be made of the carbon material so that the radiator emits the far infrared light to enable the heat to be applied directly to the user's body, thereby reducing the amount of power consumed unnecessarily and providing high thermal comfort for the user.

In addition, the heater for the electric vehicle according to the present invention is configured to allow the radiator adapted to emit heat when power is supplied from the power supply part thereto to be flexible so that it can be freely located on one or more positions of a steering wheel, doors, seats, a ceiling, arm rests, and internal frames in the electric vehicle, thereby collectively supplying the heat to the user boarding the electric vehicle.

Further, the heater for the electric vehicle according to the present invention is configured to allow the amount of power supplied from the power supply part to the radiator to be controlled by the controller, thereby easily controlling the amount of heat emitted from the radiator.

Also, the heater for the electric vehicle according to the present invention is configured to detect the user's sitting state on the seat of the electric vehicle and the user's body temperature and to thus transmit the sensed information to the controller, so that the controller automatically controls the amount of power supplied from the power supply part according to the user's body temperature of the received information.

Additionally, the heater for the electric vehicle according to the present invention is configured to allow the control signals inputted by the user terminal to be transmitted to the controller so as to control the operation of the power supply part according to the received control signals under the control of the controller, so that even in a state where the user does not board the electric vehicle, the controller remotely controls the power supply part to supply heat to the interior of the electric vehicle.

The present invention may be modified in various ways and may have several exemplary embodiments. Accordingly, it should be understood that the invention covers all the modifications, equivalents, and replacements within the idea and technical scope of the invention. Therefore, the present invention is not to be restricted by the embodiments as mentioned above. It is therefore intended that the scope of the invention be limited not by this detailed description, but rather by the claims appended hereto.

What is claimed is:

1. A heater for an electric vehicle, comprising:
a radiator (100) having a first base material (110), a plurality of heating parts (120) disposed spaced apart from one another on the underside of the first base material (110) to emit heat when power is supplied thereto, an adhesion layer (130) disposed on the undersides of the plurality of heating parts (120) to allow the plurality of heating parts (120) to come into contact with the first base material (110), and a second base material (140) disposed under the adhesion layer (130);
a power supply part (200) disposed in the electric vehicle to supply the power to the radiator (100); and
a controller (300) for controlling the operation of the power supply part (200),
wherein the adhesion layer (130) is disposed on the undersides of the plurality of heating parts (120), bent between the neighboring heating parts (120), and bonded to the underside of the first base material (110) to support the undersides of the plurality of heating parts (120), so that first air layers (150) are formed among the first base material (110), the heating parts (120), and the adhesion layer (130), and the second base material (140) is disposed under the adhesion layer (130), bent between the neighboring heating parts (120), and bonded to the adhesion layer (130), so that second air layers (160) are formed between the adhesion layer (130) and the second base material (140).

2. The heater according to claim 1, wherein the radiator (100) is located on one or more positions of a steering wheel, doors, seats, a ceiling, arm rests, and internal frames in the electric vehicle.

3. The heater according to claim 2, wherein the controller (300) controls the amount of heat emitted from the radiator (100).

4. The heater according to claim 1, further comprising a detection sensor part (400) for transmitting sensed information to the controller (300), the detection sensor part (400) comprising:
a boarding detection sensor (410) for detecting whether a user sits on a seat of the electric vehicle to produce boarding information; and
a body temperature detection sensor (420) for detecting the body temperature of the user to produce body temperature information if it is detected that the user sits on the seat.

5. The heater according to claim 4, wherein the boarding detection sensor (410) comprises:
a surface type sensing member (411) made of a flexible material and disposed on the seat of the electric vehicle;
a first conductive mesh (412) coming into contact with one surface of the surface type sensing member (411);
a second conductive mesh (413) coming into contact with the other surface of the surface type sensing member (411); and
an insulating member (414) provided to surround the first conductive mesh (412) and the second conductive mesh (413).

6. The heater according to claim 1, further comprising a user terminal (500) for transmitting the control signals inputted therewith to the controller (300), so that the controller (300) controls the operation of the power supply part (200) according to the control signals received from the user terminal (500).

7. The heater according to claim 1, wherein the radiator (100) comprises:
a heat diffusion sheet (170) attached to top of the first base material (110) to diffuse the heat emitted from the heating parts (120); and
an outer sheet (180) attached to top of the heat diffusion sheet (170).
